(19) United States
(12) Patent Application Publication
(10) Pub. No.: US 2016/0352798 A1
(43) Pub. Date: Dec. 1, 2016

(54) SYSTEMS AND METHODS FOR CAPTURE AND STREAMING OF VIDEO

(71) Applicant: USS Technologies, LLC, Rancho Cucamonga, CA (US)

(72) Inventors: Gerald Becker, Rancho Cucamonga, CA (US); Anthony Oliver, Rancho Cucamonga, CA (US)

(21) Appl. No.: 14/937,231

(22) Filed: Nov. 10, 2015

Related U.S. Application Data
(60) Provisional application No. 62/167,093, filed on May 27, 2015.

(51) Int. Cl. H04L 29/06; H04N 7/18

(52) U.S. Cl. CPC H04L 65/607; H04N 7/181; H04L 65/608; H04L 69/16; H04L 67/42; H04L 2212/00

(57) ABSTRACT

A system may provide capture and streaming of analog video, from one or more analog cameras to one or more client devices and/or servers, in a single device including capture, packetization, and streaming functionality. The device may receive one or more individual video streams and may convert and encode the streams in accordance with a video compression protocol. The device may extract frames from a buffer of the encoder, queue the frames in one or more queues according to camera, priority, location, or any other such distinctions. The device may provide queued frames to a streaming server, such as a real time streaming protocol (RTSP) server, in communication with one or more client devices, storage devices, servers, or other such devices. The device may provide self-configuration functionality, to allow interoperability with any type of network, cameras, or client devices.

### CROSS-REFERENCE TO RELATED APPLICATIONS

This application claims the benefit of and priority to as a nonprovisional application of U.S. Provisional Patent App. No. 62/167,093 entitled “Systems and Methods for Capture and Streaming of Video,” filed on May 27, 2015, the disclosure of which is incorporated herein by reference in its entirety for all purposes.

### FIELD OF THE DISCLOSURE

This disclosure generally relates to systems and methods for video capture, encoding, and streaming transmission.

### BACKGROUND OF THE DISCLOSURE

Many security systems, such as those installed in large commercial or industrial buildings, include analog video cameras. These cameras may have been installed before introduction of networked or internet protocol (IP) cameras, and accordingly, may be difficult to upgrade to provide networked functions such as remote viewing over the Internet, digital video recording, remote camera selection, etc. Furthermore, replacing these cameras may be expensive, particularly with installed systems with tens or even hundreds of cameras throughout a site.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is an illustration of a system for capture and streaming of video from analog cameras, in a first implementation;

FIG. 2 is an illustration of interactions between system components during initialization, in a second implementation;

FIG. 3 is an illustration of interactions between system components during video frame processing, according to one implementation;

FIG. 4A is a flow chart of a method for capture and streaming of video, according to one implementation;

FIG. 4B is a flow chart of a method for capture and streaming of video in which an internal encoder is utilized, according to one implementation;

FIG. 4C is a flow chart of a method for capture and streaming of video in which an external encoder is utilized, according to one implementation; and

FIGS. 5A and 5B are block diagrams depicting embodiments of computing devices useful in connection with the methods and systems described herein.

The details of various embodiments of the methods and systems are set forth in the accompanying drawings and the description below.

### DETAILED DESCRIPTION

The systems and methods described herein provide a single open architecture solution for receiving and encoding video from analog video cameras and providing the video as streamed data to client devices as part of a video management system. The system may be implemented as a single device, intermediary to cameras and network gateways or connections to remote clients, providing both encoding and streaming without additional system components, such as network switches or stand-alone video encoders, or intra-system wiring. This may reduce labor and implementation expenses, particularly with upgrade of existing analog systems such as closed circuit television systems or security systems, as well as reducing potential points of failure. In particular, the open architecture of the system may be integrated with diverse or proprietary cameras or clients in a heterogeneous system, with full flexibility to work with any component necessary. The system may also be scalable, allowing expansion over time with only incremental expense.

For purposes of reading the description of the various embodiments below, the following descriptions of the sections of the specification and their respective contents may be helpful:
Section A describes embodiments of systems and methods for capture and streaming of video; and
Section B describes a network environment and computing environment which may be useful for practicing embodiments described herein.

### A. Video Capture and Streaming

To enhance existing legacy video systems without requiring extensive replacement of system components, a system may provide capture and streaming of analog video, from one or more analog cameras to one or more client devices and/or servers, in a single device including capture, packetization, and streaming functionality. The device may receive one or more individual video streams and may convert and encode the streams in accordance with a video compression protocol, such as any of the various MPEG, AVC, or H.264 protocols, or other such protocols. The device may extract frames from a buffer of the encoder, queue the frames in one or more queues according to camera, priority, location, or any other such distinctions. The device may provide queued frames to a streaming server, such as a real time streaming protocol (RTSP) server, in communication with one or more client devices, storage devices, servers, or other such devices. The device may provide self-configuration functionality, to allow interoperability with any type of network, cameras, or client devices.

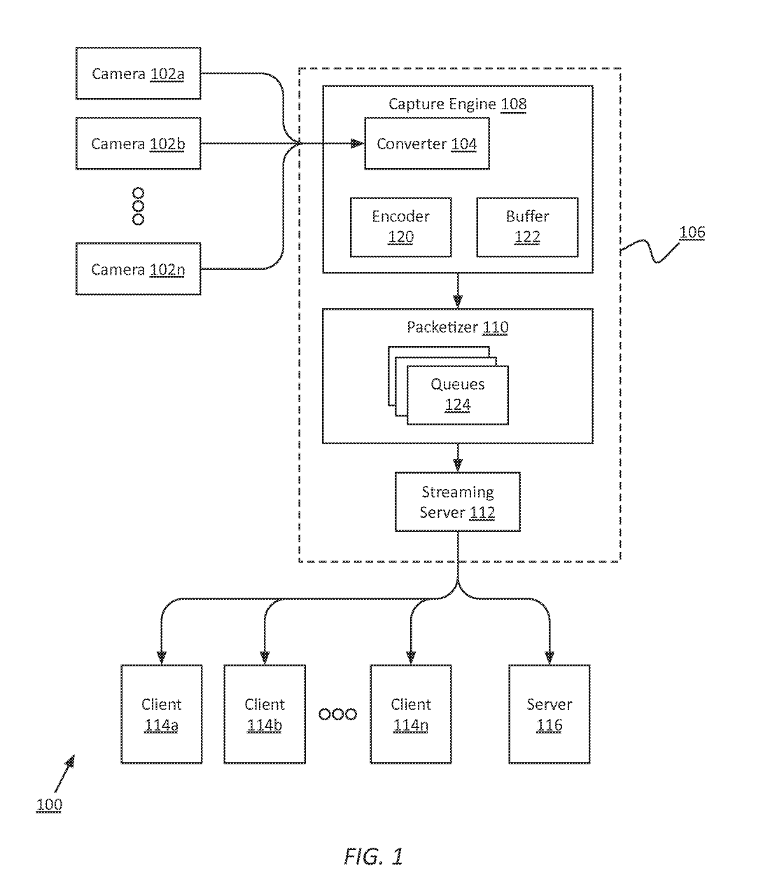

FIG. 1 is an illustration of a system 100 for capture and streaming of video from analog cameras, in a first implementation. One or more cameras 102a-102n (referred to generally as camera(s) 102 or video source(s) 102), may provide video to a converter 104. Converter 104 may receive the video and convert the video from an analog to digital form if necessary. Converter 104 may provide the video to a video capture and streaming device 106, referred to generally as a device 106. Device 106 may include a capture engine 108, which may receive the converted video and encode the video via an encoder 120 into compressed or encoded video frames (e.g. H.264 video frames). In some implementations, encoder 120 may be an internal encoder, for example, an encoder board integrated into device 106. In some implementations, encoder 120 may be an external encoder, for example, an encoder separate from but in communication with device 106. Encoder 120 may encode the video frames in a format of H.264 Network Access Layer Unit (NALU) with start codes, as described in Annex B of the ITU-T H.264 standard, in some implementations. In other implementations, encoder 120 may encode the video frames in H.265 High Efficiency Video Coding (HEVC), any of the implementations of codecs from the Motion Picture Experts Group (MPEG), or any other type and form of video coding. Capture engine 108 may store video frames in an output buffer 122 after encoding, in some implementations. Capture engine 108 may thus capture live video frames from one or more cameras and form an elementary stream in an appropriate video encoding protocol.

A packetizer 110 may receive video frames from capture engine 108 and/or may extract frames from buffer 122. In some implementations, buffer 122 is not used—packetizer 110 may receive video frames from encoder 120 directly. In some implementations, in replacement of and/or in supplement to buffer 122, a pipe or a temporary file may be used to store the encoded video frames. Packetizer 110 may queue frames for processing and streaming by a streaming server 112 in one or more queues 124. Packetizer 110 may also perform additional functions, such as aggregating frames into blocks for transfer to a streaming server 112; fragmenting video frames into a plurality of packets in implementations in which a frame is larger than a packet; encapsulating frames and/or fragments in headers (e.g. real time protocol headers, or other such protocols); or other such functions to prepare video for streaming. The packetizer 110 may accordingly encapsulate encoded video from the capture engine 108 into a transport stream (e.g. MPEG-TS or other similar transport protocols) and prepare packets for streaming by server 112.

Streaming server 112 may receive packets from packetizer 110 and may provide the packets via RTSP or other such protocol to one or more client devices 114a-114n, servers 116, content storage devices, media providers, or other such services or devices. Server 112 may implement one or more streaming and/or control protocols, such as RTSP, real time protocol (RTP), real time control protocol (RTCP), or any other such network protocols. Server 112 may provide streams via any appropriate transport layer protocol, including lossy protocols such as a user datagram protocol (UDP) or lossless protocols such as a transport layer protocol (TCP). In some implementations, streams may be provided via TCP to allow transit through firewalls that block UDP data, but may not implement a redundancy protocol. Streaming server 112 may be for example, a LIVE555 streaming server. Packetizer 110 may be built in streaming server 112, in some implementations.

Streaming server 112 and/or capture engine 108 may encode or prepare packets in any format required for compatibility with end user clients or devices or video management software (VMS) applications executed by clients. For example, many VMS manufacturers require slightly different codec or RTSP configurations for compatibility or operation, such as different RTSP uniform resource locators (URLs) or paths (e.g. RTSP://[IP address]/Medialnput/h264 vs. RTSP://[IP address]/channel_0, etc.), different default user names or passwords, different camera labeling methods, resolutions, frame rates, etc. Streaming server 112 and/or capture engine 108 may be configured to match connection or video requirements for each client, providing compatibility with different VMS applications. Such configuration may be via a command line interface, graphical user interface, or via remote control by the client (e.g. settings or options identified in an RTSP request packet). In some implementations, different connections or settings may be established for different VMS applications simultaneously or on a per-connection or per-session basis, providing simultaneous compatibility with different systems.

In some implementations, packetizer 110 may communicate with streaming server 112 and/or capture engine 108 via interprocess communications within the device. Interprocess communications may be any type and form of communications between processes on the device, including communications via an internal bus (e.g. serial or parallel bus communications); via a shared queue, shared buffer, or shared location within commonly accessible memory of the device; via semaphores, mutexes, or similar mutually accessible data structures; or any other type and form of communication. In some implementations, interprocess communications may be packetized while in other implementations, interprocess communications may be non-packetized data, such as a bitstream or data string. Interprocess communications may be distinct from inter-device communications, such as data packets transmitted and received via a network interface, such as TCP/IP packets. Although referred to as inter-device communications, in some implementations, a network interface or proxy may be used to reroute or direct packets between processes on the same device. Such packets may still be processed via a network stack of the device.

Clients 114a-114n (referred to generally as client(s) 114) may be any type and form of computing device, including desktop computers, laptop computers, tablet computers, wearable computers, smart phones, or other such devices. Clients 114 may receive streamed video via any type of network or combinations of networks, including a wide area network (WAN) such as the Internet, local area networks (LANs), cellular data networks, WiFi networks, or any other type and form of network. Clients 114 may be located local to device 106 or may be remotely located. In some implementations, clients 114 may provide control data to device 106 for selection of substreams (e.g. camera feeds). In other implementations, clients 114 may provide control data to device 106 for control of cameras (e.g. motion or focus controls), control of integrated digital video recording functions, or any other such functions. In some implementations, a server 116 may receive one or more video streams from device 106. Server 116 may be any type of computing device, similar to clients 114, and may provide additional video storage, distribution (e.g. via scaling of streaming servers), or further processing (e.g. video processing, captioning, annotation, color correction, motion interpolation, facial recognition, object recognition, optical character recognition, or any other type and form of processing).

Capture engine 108 may include one or more encoders 120 and buffers or output queues 122. Encoders 120 may include hardware, software, or a combination of hardware and software for capturing and processing one or more streams of video received from converter 104. In some implementations, although shown together in a single device, converter 104 and capture engine 108 may be separated or provided by different devices. In one implementation, converter 104 and/or capture engine 108 may be provided by a digital video recorder card or board connected to a bus of a desktop computer or server, with on-board processors performing capture and encoding functions. In some such implementations, the card may include a plurality of analog video inputs for connection to cameras, and may provide data via the bus to the computer processor.

Encoders 120 may process and encode video into one or more video streams, such as streams of H.264 video frames. In some implementations, encoders 120 may be configured by the packetizer 110 via an application programming interface (API) or communication interface between packetizer 110 and capture engine 108. In one such implementation, the packetizer 110 may configure encoder settings including frame rate, bitrate, frame resolution, or other features. The packetizer 110 may also retrieve video frames or streams of frames from one or more buffers 122. Buffers 122 may include ring buffers, first-in/first-out (FIFO) buffers, or any other type of memory storage array or device. In some implementations, capture engine 108 may have limited memory or buffer space and be only able to store a few seconds or minutes of video before overwriting older frames. As discussed in more detail below, packetizer 110 may identify when processed video frames are ready for packetizing and streaming, and may retrieve the frames from buffer 122.

In some implementations, a capture engine API may provide one or more of the following features or interface functions:

sdvr_upgrade_firmware( )—this function is used to load a firmware on to the encoder card. This function loads the contents of the given file (e.g. in a .rom format) into the encoder card memory, and directs the encoder card to burn it into volatile memory. The encoder card then automatically reboots and starts up with the new firmware, without requiring a PC reboot. This function may be called during initialization.

sdvr_board_connect_ex( )—this function connects to an encoder card and sets up communication channels and other system resources required to handle the encoder card. This function is very similar to sdvr_board_connect( ) except it provides more encoder card system settings.

sdvr_set_stream_callback( )—this function is used to register the stream callback function. In some implementations, there can be only one function registered for this callback. The callback may be called every time encoded audio and video, raw video, and/or raw audio frames are received from the encoder card. The function has as its arguments the board index, the channel number, the frame type, and identifier of the stream to which the frame belongs, and a frame category. This information can be used in the callback function to perform the appropriate action: encoded frames are saved to disk, raw video frames are displayed, and raw audio frames are played.

sdvr_create_chan( )—this function is used to create an encoding channel.

sdvr_get_video_encoder_channel_params( )—this function is used to get the parameters (frame rate, bit rate, etc.) of a video encoder channel.

sdvr_set_video_encoder_channel_params( )—this function is used to set the video parameters (as discussed above with sdvr_get_video_encoder_channel_params( )) for a specified stream of a given encoder channel.

sdvr_enable_encoder( )—this function enables the encoder stream on a particular encoder channel.

sdvr_get_stream_buffer( )—this function is called by the packetizer to get a frame from the encoder buffer.

sdvr_av_buf_payload( )—this function is called to get the encoded audio or video frame.

sdvr_release_av_buffer( )—this function is used to release an audio or video frame to the encoder. This may be used to prevent locking of the buffer by the packetizer and allow writing to the buffer by the encoder.

The packetizer 110 may also communicate with an API of the streaming server 112 to configure streaming operations. Accordingly, the packetizer 110 may act as an central intermediary or controller performing configuration and control of both capture engine 108 and streaming server 112. API methods for controlling the streaming server may include:

BasicTaskScheduler::createNew( )—this method is used to create a task scheduler, which handles new frame availability notification.

BasicUsageEnvironment::createNew( )—this method is used to create usage environment, which handles interactions with users.

RTSPServer::createNew( )—this method is used to create or instantiate an RTSP server.

ServerMediaSession::createNew( )—this method is used to create server media sessions. The server encapsulates details about subsessions and forms particular RTSP server streams. In various implementations, there may be one or more subsessions per session.

SdvrH264MediaSession::createNew( )—this method is used to create a server media subsession. The server encapsulates details about an elementary video or audio elementary stream.

ServerMediaSession::addSubsession( )—this method adds a subsession to a server media session.

RTSPServer::addServerMediaSession( )—this method adds a media session to an RTSP server.

RTSPServer::rtspURL( )—this method is used to show an RTSP stream URL to a user or client device.

BasicUsageEnvironment::taskScheduler( )—this method is used to acquire a task scheduler associated with the usage environment.

BasicTaskScheduler::doEventLoop( )—this method is used to start internal event handling on the streaming server.

SdvrSource::SignalNewFrameData( )—this method is used to send an internal event which notifies an RTSP server about new frame availability.

BasicTaskScheduler::triggerEvent( )—this method is used to record frame sources which have frames to process.

SdvrSource::deliverFrame( )—this method is used to extract available frame from queue and send it to an RTSP server. The RTSP server then packs frame data into an RTP packet and send it to connected clients.

The packetizer may also provide one or more callback functions or methods for communication to the streaming server and controlling frame queues. Functions may include:

FrameCallback( )—the callback function is used to add new available frame to a processing queue and notify the streaming server about it.

concurrent_queue<SdvrFrame*>::push( )—this method is used to add a frame to the processing queue.

concurrent_queue<SdvrFrame*>::try_pop( )—this method is used to extract a frame from the processing queue.

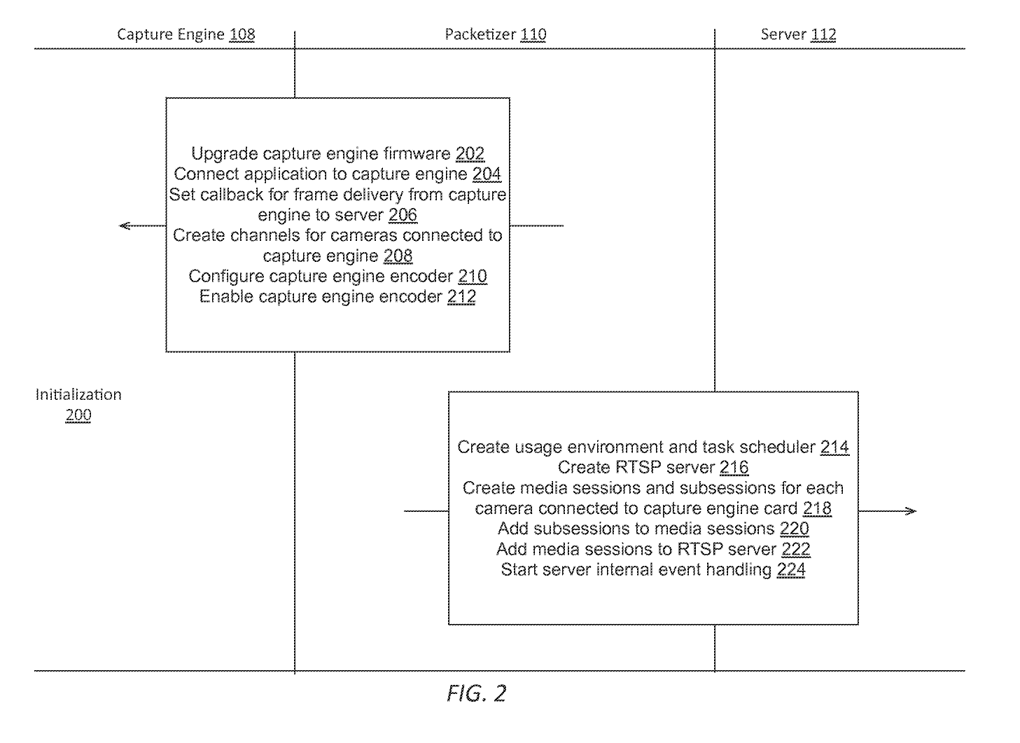

FIG. 2 is an illustration of interactions between system components during initialization 200, in a second implementation. As shown, in many implementations, system control is performed by packetizer 110 controlling upgrading, connection, and configuration of capture engine 108 and server 112.

Specifically, in one implementation, the packetizer 110 may initialize and configure the capture engine 108 and/or encoders of the capture engine, and prepare the capture engine so that the packetizer can retrieve video from buffers of the capture engine and transmit it over the network via server 112. In one such implementation, the following functions may be called in order:

sdvr_sdk_init( )—this function initializes the capture engine drivers, allocates system resources required by them, and discovers all encoder cards in the system.

sdvr_upgrade_firmware( )—this function is used at step 202 to load a firmware on to a discovered encoder card. This function loads the contents of the given file (e.g. in a .rom format) into the encoder card memory, and directs the encoder card to burn it into volatile memory. The encoder card then automatically reboots and starts up with the new firmware, without requiring a PC reboot. This function is called during initialization.

sdvr_board_connect_ex( )—this function connects to an encoder card at step 204 and sets up communication channels and other system resources required to handle the encoder card.

sdvr_set_stream_callback( )—this function is used to register the stream callback function at step 206. In some implementations, there can be only one function registered for this callback. The callback may be called every time encoded audio or video, raw video, and raw audio frames are received from the encoder card. The function has as its arguments the board index, the channel number, the frame type, the ID of the stream to which the frame belongs, and/or a frame category. This information can be used in the callback function to perform the appropriate action.

Once connection and callback setup is complete, channels are set up for each camera to be accessed over the network. Each channel may be a representation of one physical camera, in some implementations. In others, multiple cameras may be multiplexed to a channel or sub-channels of a channel.

sdvr_create_chan( )—this function is used at step 208 to create an encoding channel.

Once encoding channels are set up, each channel may be configured with one or more streams in order to access video at different quality levels from a single camera. Each stream has its own video encoder settings. This allows receiving video with different quality from a single camera.

sdvr_get_video_encoder_channel_params( )—this function is used at step 210 to get the parameters (frame rate, bit rate, etc.) of a specified stream of a given encoder channel.

sdvr_set_video_encoder_channel_params( )—this function is also used at step 210 to set the video parameters (same as sdvr_get_video_encoder_channelparams( )) for a specified stream of a given encoder channel.

sdvr_enable_encoder( )—this function is used at step 212 to enable the encoder stream on a particular encoder stream.

Once the encoder card is properly initialized and configured, the packetizer 110 may configure and start an RTSP server 112. The server delivers video captured by the encoder card to clients (video players, archivers, etc.). In order to create the RTSP server, the packetizer may call the following methods:

TaskScheduler::createNew( )—this method is used at step 214 to create a task scheduler, which handles new frame availability notification.

RTSPServer::createNew( )—this method is used at step 216 to create an RTSP server instance on a particular port.

When the RTSP server has started, the packetizer may configure the server to get video frames from packetizer queues and send them to connected clients, via the following methods:

ServerMediaSession::createNew( )—this method is used at step 218 to create a server media session. Each media session represents a server media stream, which has its own URL and can contain multiple elementary media streams (separate audio or video). Each encoder card stream may have its own server media session and URL.

SdvrH264MediaSession::createNew( )—this method may be used at step 220 to create server media subsessions. The subsession creates H264VideoStreamDiscreteFramer and SdvrSource objects when a client device connects to the server. The SdvrSource object is used to fill up the RTSP server buffer with video frames from packetizer queues. The H264VideoStreamDiscreteFramer object is used to convert buffered video frames to an internal RTSP server representation.

ServerMediaSession::addSubsession( )—this method may be used at step 220 to add a subsession to a server media session.

RTSPServer::addServerMediaSession( )—this method is used at step 222 to add a media session to an RTSP server.

TaskScheduler::doEventLoop( )—this method is used at step 224 to start internal event handling.

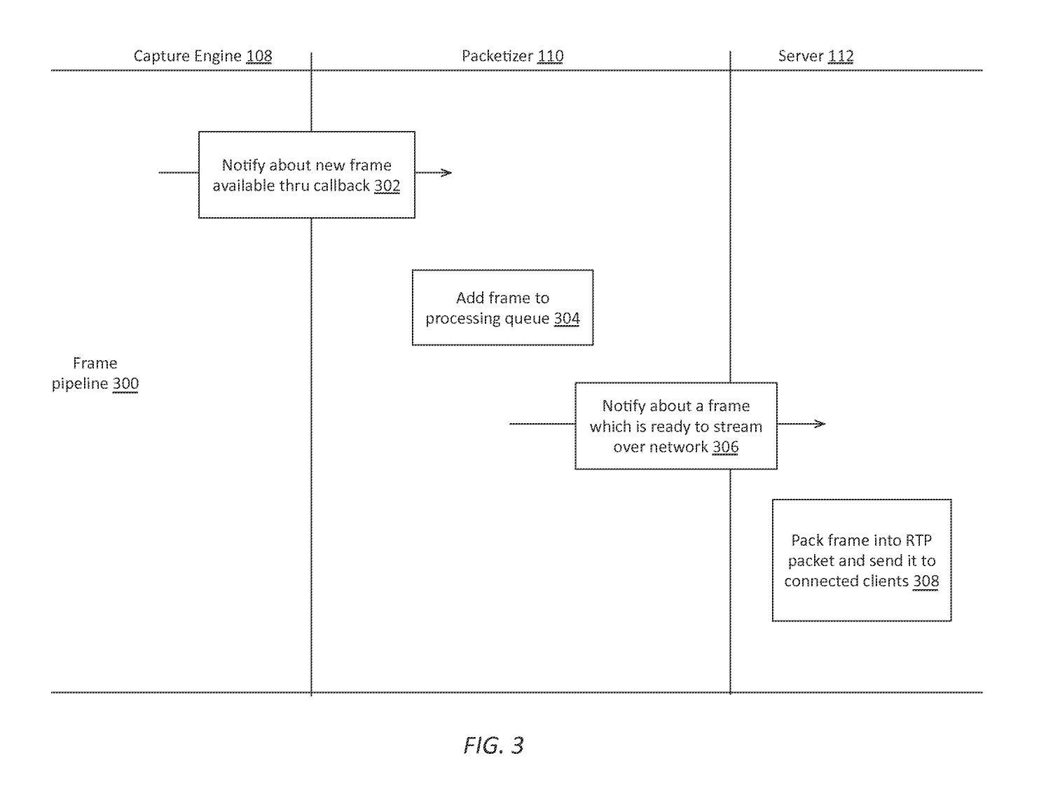

FIG. 3 is an illustration of interactions between system components during video frame processing 300, according to one implementation. Once the encoder is initialized and enabled as discussed above, the encoder calls a FrameCallback( ) function at step 302 every time a new frame is encoded and/or stored in a buffer of the capture engine.

FrameCallback( )—this function is used to get a video frame from an encoder card, add it to a processing queue and notify an RTSP server about the availability of the new frame. FrameCallback( ) uses the following function calls to get frames from the encoder card buffer at step 304:

sdvr_get_stream_buffer( )—this function is used to access a frame buffer of the encoder card.

sdvr_av_buf_payload( )—this function is called to get the encoded audio or video frame.

sdvr_release_av_buffer( )—this function is used to release a frame buffer of the encoder card.

After copying video frame from the encoder card buffer to a processing queue of the packetizer 110, the FrameCallback( )method calls SdvrSource::SignalNewFrameData( ) to notify the server about the new frame availability, at step 306.

SdvrSource::SignalNewFrameData( )—this method is used to send a streaming server internal event which notifies the RTSP server about the new frame availability. SdvrSource::SignalNewFrameData( ) calls the BasicTaskScheduler::triggerEvent( )method to handle events in a continuously running TaskScheduler::doEventLoop( ) The task scheduler calls SdvrSource::deliverFrame( ) to deliver the frame from a processing queue of the packetizer 110 to the RTSP server.

BasicTaskScheduler::triggerEvent( )—this method is used to record frame sources which have frames to process.

SdvrSource::deliverFrame( )—this method is used to extract an available frame from queue and copy it to an RTSP server buffer. The RTSP server then packs the buffered frame data into an RTP packet and sends it to connected clients at step 308.

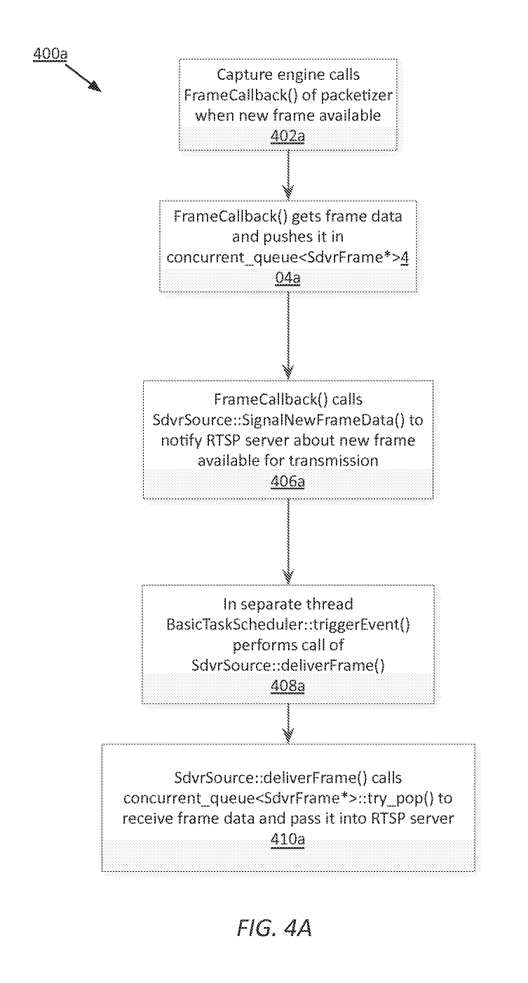

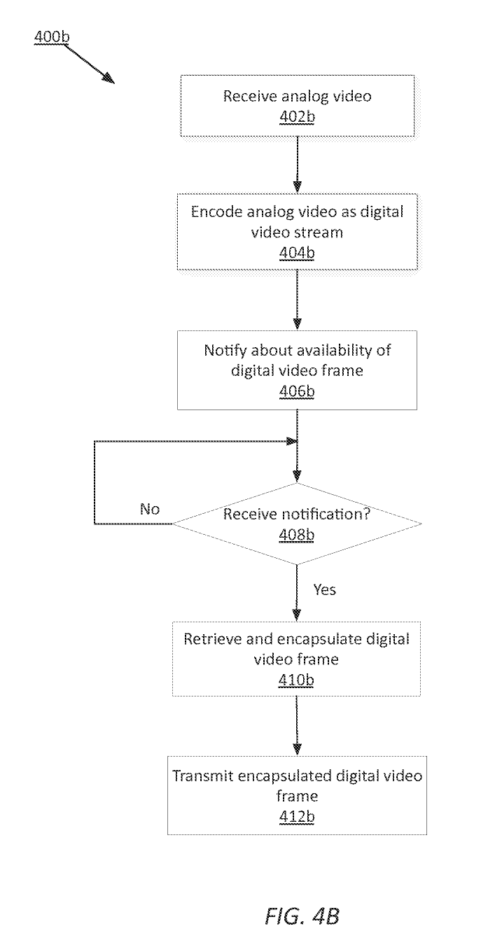

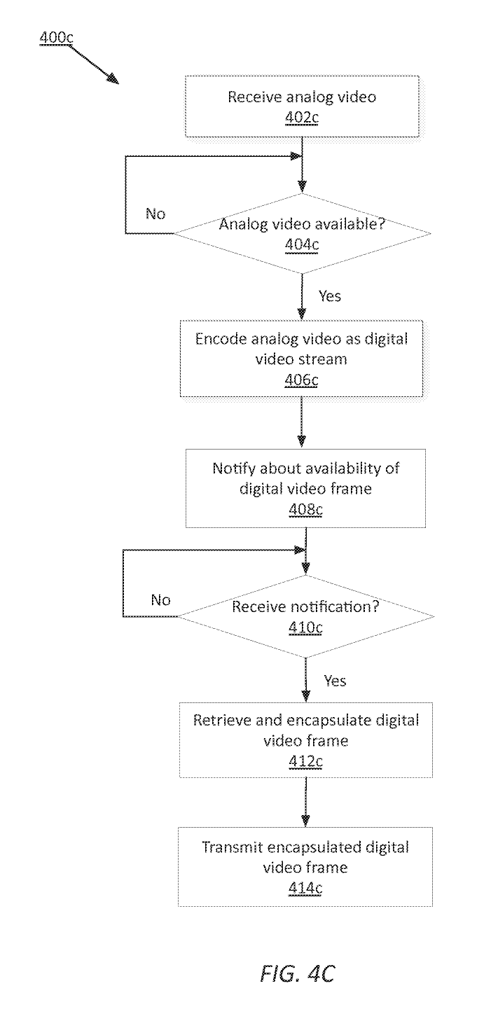

FIG. 4A is a flow chart of a method 400a for capture and streaming of video, according to one implementation. At step 402a, a capture engine transmits a notification to a packetizer when a new frame of video has been encoded and is available for queuing and processing in a buffer of the capture engine. At step 404a, the packetizer retrieves the frame data and places it into a queue for the stream or substream corresponding to the video source. In some implementations, a Concurrency::concurrent_queue<T> class from Microsoft API may be utilized for queue operations. In some implementations, the packetizer may process the frame, packetize the frame, encapsulate the frame in an RTP protocol, fragment the frame to meet maximum transmission unit requirements, or perform other functions.

At step 406a, the packetizer transmits a notification to a streaming server that a new frame is available in the queue. At step 408a, responsive to the notification, a task scheduler of the server retrieves the new frame and provides the frame to the streaming server. As discussed above, in some implementations, the Concurrency::concurrent_queue<T> class from Microsoft API may be used for the queue operations. This API may be configured to manage concurrent operations. The packetizer and the streaming server may utilize pointers on a queue object to manage reading and processing of the queue. The server may then transmit the frame to one or more client devices or other such devices for viewing or storage.

Accordingly, by serving as an intermediary controller and queue manager, the packetizer 110 may retrieve individual frames from output buffers of the encoders and packetize and queue the frames into a packet stream for retrieval and transmission by RTSP servers.

FIG. 4B is a flow chart of a method 400b for capture and streaming of video in which an internal encoder is utilized, according to one implementation. The internal encoder may be an encoder board integrated into a streaming server, in some implementations. At step 402b, a capture engine may receive one or more analog videos from one or more video cameras coupled to one or more analog video inputs of the capture engine. At step 404b, the internal encoder may encode the analog video received to a digital video stream. In some implementations, the digital video stream includes frame(s) in a format of H.264 Network Access Layer Unit (NALU) with start codes, as described in Annex B of ITU-T H.264 standard, or in any other formats including MPEG video, HEVC video, or any other type of video coding. At step 406b, the encoder may notify a packetizer about availability of newly encoded digital video frame(s). In some implementations, the packetizer is built in the streaming server. The notifying action may be implemented through queue operations, call backs, flags in mutually shared or monitored memory locations, interprocess communications, or any other type and form of notifying action. In one implementation, the encoder may push the newly encoded frame to a rear of a queue, change a pointer to the new rear of the queue, and notify the packetizer of the new pointer to the rear of the queue.

At step 408b, in some implementations, the packetizer may run a loop checking whether a notification about the newly encoded frame(s) has been received. Such checking may be performed by checking the status of a flag, contents of a shared memory location, an input buffer or memory location for an interprocess communication, or any other such methods. At step 410b, the packetizer, responsive to receipt of the notification, may retrieve the frame(s) and encapsulate the frame(s) in a real time streaming protocol such as RTSP, RTP, or the RTCP standard. Encapsulating the frames may comprise adding a header and/or a footer to the frame of data; encoding, compressing, or encrypting the frames as a payload of a packet; or otherwise processing the packet to be compatible with a streaming protocol. At step 412b, the streaming server may transmit the encapsulated digital video frame(s) via one or more network interfaces, such as wireless network interfaces, wired network interfaces, cellular network interfaces, or any other type and form of network interface. In some implementations, lossy protocols such as a user datagram protocol (UDP) may be utilized to transmit RTSP frames. In some implementations, lossless protocols such as a transport layer protocol (TCP) may be utilized to transmit RTP and/or RTCP frames. The server may transmit the frame(s) to one or more client devices or other such devices for viewing or storage.

FIG. 4C is a flow chart of a method 400c for capture and streaming of video in which an external encoder is utilized, according to one implementation. The external encoder may be an encoding device separate from but in communication with a streaming server, in some implementations. Step 402c is similar to step 402b illustrated in FIG. 4B. A capture engine may receive one or more analog videos from one or more video cameras coupled to one or more analog video inputs of the capture engine.

At step 404c, in another thread, the external encoder may run a loop checking the availability of analog video for encoding. In some implementations, the availability checking may be implemented through queue operations, monitoring of process or encoding activity, monitoring of synchronization signals in the video such as a vertical blanking interval signal, or other such operations. In some implementations, the capture engine may push the received analog video picture(s) to a rear of a queue and change a pointer to the new rear of the queue. The encoder loop checks the pointer to the rear periodically and determines that analog video picture is available for encoding if the pointer has changed in comparison to a prior check. At step 406c, the encoder, responsive to determining that analog video picture is available, may encode the analog video picture(s) to a digital video stream. Step 408c is similar to step 406b illustrated in FIG. 4B, and may use any of the encoding methods discussed above. The encoder may notify a packetizer about availability of newly encoded digital video frame(s) through any method discussed above, including interprocess communications, flags, status messages, callbacks, etc.

Step 410c is similar to step 408b in FIG. 4B. The packetizer may run a loop checking whether a notification about the newly encoded frame(s) has been received. At step 412c, the packetizer, responsive to receipt of the notification, may retrieve the frame(s) and encapsulate the frame(s) in a real time streaming protocol such as RTSP, RTP, or RTCP standard or any similar protocol. At step 414c, the streaming server transmits the encapsulated digital video frame(s) via one or more network interfaces. The server may transmit the frame(s) to one or more client devices or other such devices for viewing or storage.

It shall be appreciated that the flow charts described above are set forth as representative implementations. Other implementations may include more, fewer, or different steps and may be of different orderings.

### B. Computing and Network Environment

Having discussed specific embodiments of the present solution, it may be helpful to describe aspects of the operating environment as well as associated system components (e.g., hardware elements) in connection with the methods and systems described herein.

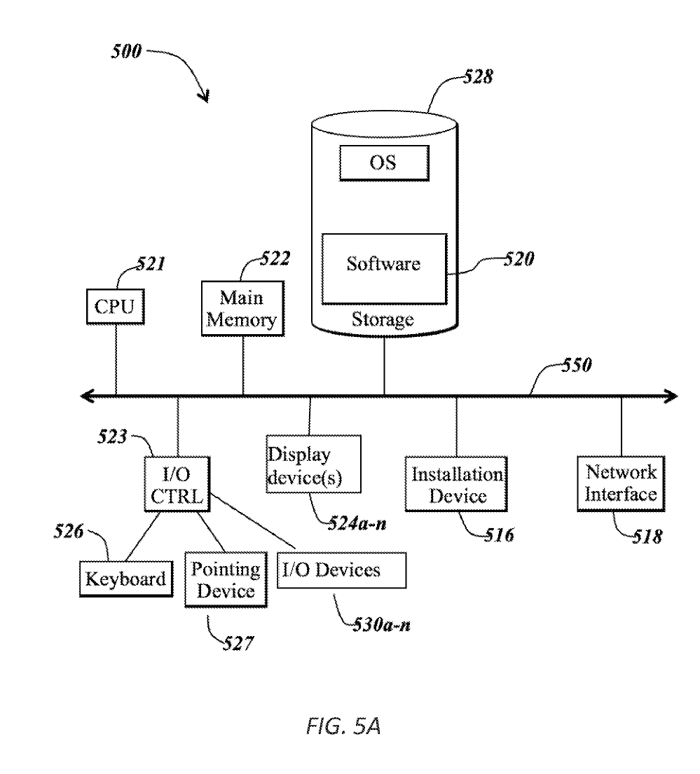

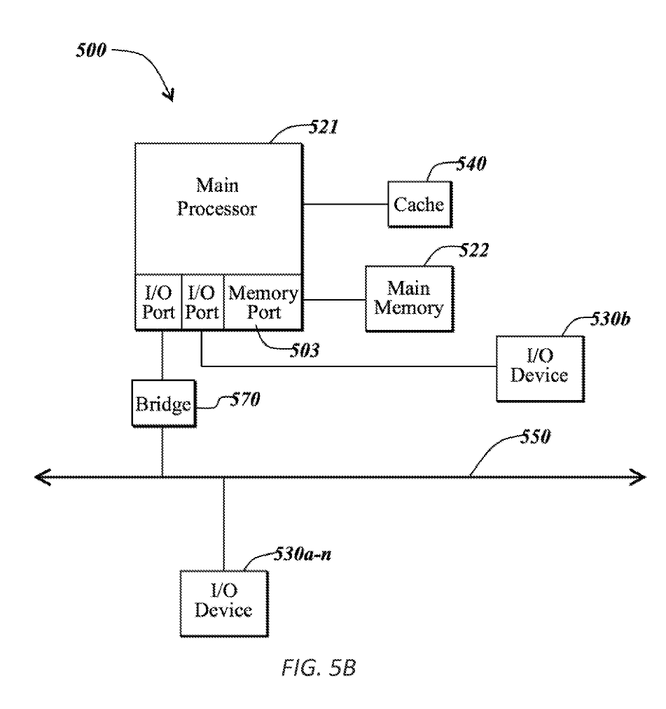

FIGS. 5A and 5B depict block diagrams of a computing device 500 useful for practicing an embodiment of the converter 104, system 106, clients 114, or server 116. As shown in FIGS. 5A and 5B, each computing device 500 includes a central processing unit 521, and a main memory unit 522. As shown in FIG. 5A, a computing device 500 may include a storage device 528, an installation device 516, a network interface 518, an I/O controller 523, display devices 524a-524n, a keyboard 526 and a pointing device 527, such as a mouse. The storage device 528 may include, without limitation, an operating system and/or software. As shown in FIG. 5B, each computing device 500 may also include additional optional elements, such as a memory port 503, a bridge 570, one or more input/output devices 530a-530n (generally referred to using reference numeral 530), and a cache memory 540 in communication with the central processing unit 521.

The central processing unit 521 is any logic circuitry that responds to and processes instructions fetched from the main memory unit 522. In many embodiments, the central processing unit 521 is provided by a microprocessor unit, such as: those manufactured by Intel Corporation of Mountain View, Calif.; those manufactured by International Business Machines of White Plains, N.Y.; or those manufactured by Advanced Micro Devices of Sunnyvale, Calif. The computing device 500 may be based on any of these processors, or any other processor capable of operating as described herein.

Main memory unit 522 may be one or more memory chips capable of storing data and allowing any storage location to be directly accessed by the microprocessor 521, such as any type or variant of Static random access memory (SRAM), Dynamic random access memory (DRAM), Ferroelectric RAM (FRAM), NAND Flash, NOR Flash and Solid State Drives (SSD). The main memory 522 may be based on any of the above described memory chips, or any other available memory chips capable of operating as described herein. In the embodiment shown in FIG. 5A, the processor 521 communicates with main memory 522 via a system bus 550 (described in more detail below). FIG. 5B depicts an embodiment of a computing device 500 in which the processor communicates directly with main memory 522 via a memory port 503. For example, in FIG. 5B the main memory 522 may be DRDRAM.

FIG. 5B depicts an embodiment in which the main processor 521 communicates directly with cache memory 540 via a secondary bus, sometimes referred to as a backside bus. In other embodiments, the main processor 521 communicates with cache memory 540 using the system bus 550. Cache memory 540 typically has a faster response time than main memory 522 and is provided by, for example, SRAM, BSRAM, or EDRAM. In the embodiment shown in FIG. 5B, the processor 521 communicates with various I/O devices 530 via a local system bus 550. Various buses may be used to connect the central processing unit 521 to any of the I/O devices 530, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 524, the processor 521 may use an Advanced Graphics Port (AGP) to communicate with the display 524. FIG. 5B depicts an embodiment of a computer 500 in which the main processor 521 may communicate directly with I/O device 530b, for example via HYPERTRANSPORT, RAPIDIO, or INFINIBAND communications technology. FIG. 5B also depicts an embodiment in which local busses and direct communication are mixed: the processor 521 communicates with I/O device 530a using a local interconnect bus while communicating with I/O device 530b directly.

A wide variety of I/O devices 530a-530n may be present in the computing device 500. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 523 as shown in FIG. 5A. The I/O controller may control one or more I/O devices such as a keyboard 526 and a pointing device 527, e.g., a mouse or optical pen. Furthermore, an I/O device may also provide storage and/or an installation medium 516 for the computing device 500. In still other embodiments, the computing device 500 may provide USB connections (not shown) to receive handheld USB storage devices such as the USB Flash Drive line of devices manufactured by Twintech Industry, Inc. of Los Alamitos, Calif.

Referring again to FIG. 5A, the computing device 500 may support any suitable installation device 516, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 500 may further include a storage device, such as one or more hard disk drives or redundant arrays of independent disks, for storing an operating system and other related software, and for storing application software programs such as any program or software 520 for implementing (e.g., configured and/or designed for) the systems and methods described herein. Optionally, any of the installation devices 516 could also be used as the storage device. Additionally, the operating system and the software can be run from a bootable medium.

Furthermore, the computing device 500 may include a network interface 518 to interface to the network 504 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11 ad, CDMA, GSM, WiMax and direct asynchronous connections). In one embodiment, the computing device 500 communicates with other computing devices 500′ via any type and/or form of gateway or tunneling protocol such as Secure Socket Layer (SSL) or Transport Layer Security (TLS). The network interface 518 may include a built-in network adapter, network interface card, PCMCIA network card, card bus network adapter, wireless network adapter, USB network adapter, modem or any other device suitable for interfacing the computing device 500 to any type of network capable of communication and performing the operations described herein.

In some embodiments, the computing device 500 may include or be connected to one or more display devices 524a-524n. As such, any of the I/O devices 530a-530n and/or the I/O controller 523 may include any type and/or form of suitable hardware, software, or combination of hardware and software to support, enable or provide for the connection and use of the display device(s) 524a-524n by the computing device 500. For example, the computing device 500 may include any type and/or form of video adapter, video card, driver, and/or library to interface, communicate, connect or otherwise use the display device(s) 524a-524n. In one embodiment, a video adapter may include multiple connectors to interface to the display device(s) 524a-524n. In other embodiments, the computing device 500 may include multiple video adapters, with each video adapter connected to the display device(s) 524a-524n. In some embodiments, any portion of the operating system of the computing device 500 may be configured for using multiple displays 524a-524n. One ordinarily skilled in the art will recognize and appreciate the various ways and embodiments that a computing device 500 may be configured to have one or more display devices 524a-524n.

In further embodiments, an I/O device 530 may be a bridge between the system bus 550 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 500 of the sort depicted in FIGS. 5A and 5B may operate under the control of an operating system, which control scheduling of tasks and access to system resources. The computing device 500 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer system 500 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 500 has sufficient processor power and memory capacity to perform the operations described herein.

In some embodiments, the computing device 500 may have different processors, operating systems, and input devices consistent with the device. For example, in one embodiment, the computing device 500 is a smart phone, mobile device, tablet or personal digital assistant. In still other embodiments, the computing device 500 is an Android-based mobile device, an iPhone smart phone manufactured by Apple Computer of Cupertino, Calif., or a Blackberry or WebOS-based handheld device or smart phone, such as the devices manufactured by Research In Motion Limited. Moreover, the computing device 500 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices or stations (STAs), for example, consistent with the terms “user” and “multi-user” typically used in the context of a multi-user multiple-input and multiple-output (MU-MIMO) environment.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

1. A video capture and streaming device, comprising:
a plurality of analog video inputs;
at least one network interface;
a capture engine within the video capture and streaming device configured to couple to at least one video camera via a corresponding at least one analog video input of the plurality of analog video inputs, and comprising an output buffer at a first location in memory of the device and further comprising an encoder configured to receive analog video of the at least one video camera and encode the received analog video as a digital video stream, each frame of the encoded digital video stream placed in the output buffer;
a streaming server within the video capture and streaming device in communication with the capture engine to obtain the digital video stream via a local interprocess communication, the streaming server configured to transmit, via the at least one network interface, the digital video stream to at least one remote device via a real time streaming protocol, the streaming server comprising an input buffer at a second location in memory of the video capture and streaming device;
a packetizer within the video capture and streaming device configured as an intermediary between the capture engine and the streaming server, the packetizer configured to retrieve a frame of video from the output buffer of the capture engine responsive to receipt from the capture engine of an identification of the frame being added to the output buffer, encapsulate the frame of video in the real time streaming protocol, store the encapsulated frame in the input buffer of the streaming server, and provide a notification to the streaming server of the placement of the encapsulated frame in the input buffer.

2. (canceled)

3. (canceled)

4. The video capture and streaming device of claim 1, wherein the output buffer comprises a ring buffer, and wherein the capture engine overwrites frames of video stored in the ring buffer, responsive to receiving the analog video.

5. (canceled)

6. (canceled)

7. The video capture and streaming device of claim 1, wherein the packetizer is further configured to configure the capture engine and the streaming server for operation.

8. The video capture and streaming device of claim 1, wherein the capture engine is coupled to a plurality of video cameras, and is further configured to receive analog video from the plurality of video cameras, encode the received analog video from each of the plurality of video cameras, and multiplex the encoded video.

9. The video capture and streaming device of claim 8, wherein the capture engine is further configured to generate an identifier for each encoded video of the multiplexed video, the generated identifiers provided to the streaming server.

10. The video capture and streaming device of claim 9, wherein the streaming server is further configured to:
receive, from a remote device, a request for video from a first video camera of the plurality of video cameras;
identify a corresponding identifier of the video from the first video camera; and
transmit a request to the capture engine to provide the video from the first video camera to the streaming server without multiplexing the video, the request comprising the identifier.

11. A method, comprising:
receiving, by a capture engine of a device from at least one video camera coupled to an input of the device, analog video;
encoding, by an encoder of the capture engine, the analog video as a digital video stream, the digital video stream stored in an output buffer of the capture engine at a first location in a memory of the device;
receiving from the capture engine, by a packetizer within the device configured as an intermediary between the capture engine and a streaming server within the device, an identification of a frame of video of the digital video stream output by the capture engine added to the output buffer of the capture engine;
retrieving, by the packetizer, the frame of video of the digital video stream output by the capture engine from the output buffer, responsive to receipt of the identification of the frame added to the output buffer of the capture engine;
encapsulating, by the packetizer, the retrieved frame in the real time streaming protocol;
storing, by the packetizer, the encapsulated frame in an input buffer of the streaming server;
providing a notification, by the packetizer to the streaming server, of the placement of the encapsulated frame in the input buffer of the streaming server;
obtaining, by the streaming server, the encapsulated frame from the input buffer responsive to receipt of the notification of the placement of the encapsulated frame in the input buffer of the streaming server; and
transmitting, by the streaming server to at least one remote device via at least one network interface of the device, the digital video stream via a real time streaming protocol.

12. (canceled)

13. (canceled)

14. The method of claim 11, wherein the output buffer comprises a ring buffer; and further comprising overwriting a frame of video stored in the ring buffer, by the capture engine, responsive to receiving the analog video.

15. (canceled)

16. (canceled)

17. The method of claim 11, further comprising configuring, by the packetizer, the capture engine and the streaming server for operation.

18. The method of claim 11, wherein the capture engine is coupled to a plurality of video cameras; and further comprising:
receiving, by the capture engine, analog video from the plurality of video cameras;
encoding, by the encoder, the received analog video from each of the plurality of video cameras; and
multiplexing, by the encoder, the encoded video.

19. The method of claim 18, further comprising generating an identifier, by the capture engine, for each encoded video of the multiplexed video, the generated identifiers provided to the streaming server.

20. The method of claim 19, further comprising:
receiving, by the streaming server from a remote device, a request for video from a first video camera of the plurality of video cameras;
identifying, by the streaming server, a corresponding identifier of the video from the first video camera; and
transmitting a request to the capture engine, by the streaming server, to provide the video from the first video camera without multiplexing the video, the request comprising the identifier.

21. The video capture and streaming device of claim 1, wherein the capture engine is further configured to provide an application programming interface (API) callback to the packetizer.

22. The video capture and streaming device of claim 21, wherein the packetizer is further configured to transmit a notification of storing the encapsulated frame in the input buffer to the streaming server, responsive to receipt of the API callback from the capture engine.

23. The video capture and streaming device of claim 1, wherein the packetizer is further configured to manage a pointer of the input buffer of the streaming server.

24. The video capture and streaming device of claim 1, wherein the packetizer is further configured to check the status of a flag set by the encoder to identify the presence of a newly encoded frame of video in the output buffer.
